(19) United States
(12) Patent Application Publication
(10) Pub. No.: US 2025/0014388 A1
(43) Pub. Date: Jan. 9, 2025

(54) SYSTEMS AND METHODS FOR PREDICTING AN EMOTION IN REAL-TIME BASED ON PHYSICAL GESTURES

(71) Applicant: Wells Fargo Bank, N.A., San Francisco, CA (US)

(72) Inventors: Vinothkumar Venkataraman, Bangalore (IN); Rahul Ignatius, Bangalore (IN); Naveen Gururaja Yeri, Bangalore (IN); Paul Davis, Irving, TX (US); Saurav Kumar, Bangalore (IN); Ramesh Babu Sarvesetty, Bangalore (IN)

(21) Appl. No.: 17/452,949

(22) Filed: Oct. 29, 2021

(51) Int. Cl. G06K 9/00; G06K 9/36; G06N 3/04; G06Q 10/06

(52) U.S. Cl. CPC G06V 40/20; G06N 3/045; G06Q 10/06398; G06V 10/20; G06V 40/10; G06V 40/161; G06V 40/168

(57) ABSTRACT

Systems, apparatuses, methods, and computer program products are disclosed for predicting an emotion in real-time based on facial gestures and limb gestures derived from captured images. An example method includes receiving a series of images captured in real-time. The example method further includes causing generation of a face segmentation and one or more limb segmentations using the series of images. The example method further extracting one or more face segmentations vectors and one or more limb segmentation vectors. The example method further includes causing generation of weighted vectors using the one or more face segmentation vectors and the one or more limb segmentation vectors for each of the one or more the limb segmentations. The example method includes calculating a probability distribution based on the one or more probabilities corresponding to one or more emotions. The example method finally includes determining a predicted emotion based on the probability distribution.

### TECHNOLOGICAL FIELD

Example embodiments of the present disclosure relate generally to predicting emotions based on physical gestures, such as facial gestures and limb gestures and, more particularly, to systems and methods for predicting one or more emotions in real-time based on such gestures derived from captured images.

### BACKGROUND

Many institutions, such as banks and other service and product providers, offer in-person and video based services. Currently, customers or other users may meet with an agent or customer service representative either in-person or via video. A customer or other user may give feedback based on such an interaction. Currently, agents or customer service representatives infer a customer's emotion based on the agent's or customer service representative's subjective visual inspection of a customer or other user. While a customer or other user may appear to exhibit a particular emotion, the customer or other user may actually be experiencing a different or additional emotions. There is no objective framework or standard for understanding customer emotions and experience in traditional environments, which decreases overall understanding of an agent's or customer service representative's performance, as well as performance by a particular branch, store, or location, thus preventing the implementation of changes to increase customer satisfaction.

### BRIEF SUMMARY

Emotion prediction is utilized in various fields today. However, current in-person and/or face-to-face interactions today do not effectively harness the opportunities afforded by various emotion prediction systems. For instance, emotion predictions are not utilized when determining how a branch or store performs in relation to customer and/or agent emotions predicted in real-time for in-person and/or video based interactions.

Accordingly, Applicant has recognized a need for systems, methods, and apparatuses for predicting emotions in real-time based on facial gestures and limb gestures derived from captured images. Predicted emotion(s) can be utilized to ensure that an agent receives a next action and/or determine an agent's and/or branch's or store's performance to ensure that customers are not negatively impacted. Utilizing the customer's facial expressions and limb gestures, based on or derived from the captured images, example embodiments detect a customer's emotion in real-time for use in providing potential next actions for an agent and/or determining, real-time and after the interaction, an agent's performance. To this end, example systems described herein analyze a series of images captured from a customer and agent interaction using several machine learning models or classifiers. Based on this analysis, example embodiments may predict the customer's and/or agent's emotion, which in turn may be utilized in determining a next action for the agent and/or in real-time and/or later determining an agent's and/or branch's or store's performance.

Systems, apparatuses, methods, and computer program products are disclosed herein for predicting an emotion based on facial gestures and limb gestures derived from captured images. The predicted emotions may be utilized to determine the next best action or personalized action. For instance, an agent may be directed to bring a manager into the interaction or bring in another agent capable of handling customers in the particular customer's current emotional state. Further, the predicted emotions may be stored in memory, along with associated metadata, and utilized for determining an agent's performance and/or the cumulative performance of a branch or store. For example, agents at a particular branch or store of a company may interact with a number of customers throughout a day. Each interaction may produce a net gesture index based on the predicted emotion. A user interface may include statistics that can be visualized based on selectable fields from the metadata, such as time, date, day, month, customer information, employee information, entity, agent, and/or branch, among other aspects. Based on such visualizations, corrective action may be taken.

In one example embodiment, a method is provided for predicting an emotion in real-time based on facial gestures and limb gestures derived from captured images. The method may include receiving, by an image capture and processing circuitry, a series of images captured in real-time. The method may include causing, by a body part detection circuitry and using the series of images, generation of one or more face segmentations and one or more limb segmentations. The method may include extracting, by the body part detection circuitry and using the one or more face segmentations, one or more face segmentation vectors. The method may include extracting, by the body part detection circuitry and using the one or more limb segmentations, one or more limb segmentation vectors. The method may include causing, by a gesture intelligence circuitry, generation of weighted vectors using the one or more face segmentation vectors and the one or more limb segmentation vectors. The method may include normalizing, via a Softmax layer of the gesture intelligence circuitry, the weighted vectors to form one or more probabilities corresponding to one or more emotions. The method may include calculating, via the Softmax layer of the gesture intelligence circuitry, a probability distribution based on the one or more probabilities corresponding to one or more emotions. The method may include determining, by the gesture intelligence circuitry, one or more predicted emotions based on the probability distribution.

In another embodiment, the method may include, prior to extraction of the one or more face segmentations and the one or more limb segmentations, pre-processing, by the image capture and processing circuitry, the series of images. Pre-processing the series of images may include applying one or more resizing, denoising, smoothing edges, brightness correction, gamma correction, and geometric transformation operations to the series of images.

In another embodiment, each of the one or more limb segmentations may include a portion of a customer's or agent's body that is different than that of each other of the one or more limb segmentations.

In another embodiment, the generation of the one or more face segmentations and the one or more limb segmentation may include using one or more of the recurrent convolutional neural network and the feedforward network. The body part detection circuitry may include a face segmentation recurrent convolutional neural network and a limb segmentation recurrent convolutional neural network. Extracting the one or more face segmentation vectors may additionally use the face segmentation recurrent convolutional neural network. Extracting the one or more limb segmentation vectors may additionally use the limb segmentation recurrent convolutional neural network.

In another embodiment, the method may include, prior to normalizing the weighted vectors, causing, by the gesture intelligence circuitry, generation of final vectors using the weighted vectors and a dense feedforward neural network.

In another embodiment, the series of images may be captured by an image capture device. The series of images may depict a portion of a customer interaction. The one or more predicted emotions may include a specific predicted emotion for each portion of the customer interaction in real-time. In such embodiments, the method may include causing, by the gesture intelligence circuitry, generation of a net gesture index using each of the one or more specific predicted emotions for the customer interaction. Further, the method may include storing the net gesture index of the customer interaction with associated metadata in memory. The method may also include generating, via the gesture intelligence circuitry, a user interface including previously generated net gesture indices in relation to one or more selectable categories corresponding to the associated metadata. The associated metadata may include one or more of a location, a time, a date, a day, a month, customer information, employee information, and entity.

In another embodiment, the method may include determining, by the gesture intelligence circuitry, a next action based on the one or more predicted emotions. The next action may include providing one or more of personalized product recommendations and personalized service recommendations. Each of the one or more predicted emotions may correspond to a portion of a current customer interaction. Determining the next action may further be based on previously predicted emotions of prior portions of the current customer interaction.

In one example embodiment, an apparatus is provided for predicting an emotion in real-time based on facial gestures and limb gestures derived from captured images. The apparatus may include an image capture and processing circuitry configured to receive a series of images captured in real-time. The apparatus may include a body part detection circuitry. The body part detection circuitry may be configured to cause, using the series of images, generation of one or more face segmentations and one or more limb segmentations. The body part detection circuitry may be configured to extract, using the one or more face segmentations, one or more face segmentation vectors. The body part detection circuitry may be configured to extract, using the one or more limb segmentations, one or more limb segmentation vectors. The apparatus may include a gesture intelligence circuitry. The gesture intelligence circuitry may be configured to cause generation of weighted vectors using the one or more face segmentation vectors and the one or more limb segmentation vectors. The gesture intelligence circuitry may be configured to normalize, via a Softmax layer, the weighted vectors to form one or more probabilities corresponding to one or more emotions. The gesture intelligence circuitry may be configured to calculate, via the Softmax layer, a probability distribution based on the one or more probabilities corresponding to one or more emotions. The gesture intelligence circuitry may be configured to determine one or more predicted emotions based on the probability distribution.

In another embodiment, the series of images may depict one or more of an agent and customer. The gesture intelligence circuitry may be further configured to determine an agent's performance based on the one or more predicted emotions.

In one example embodiment, a computer program product is provided for predicting a customer's emotions. The computer program product may comprise at least one non-transitory computer-readable storage medium storing software instructions that, when executed, cause an apparatus to perform actions. The software instructions, when executed, may receive a series of images captured in real-time. The software instructions, when executed, may cause, using the series of images, generation of one or more face segmentations and one or more limb segmentations using the series of images. The software instructions, when executed, may extract, using the one or more face segmentations, one or more face segmentation vectors. The software instructions, when executed, may extract, using the one or more limb segmentations, one or more limb segmentation vectors. The software instructions, when executed, may cause generation of weighted vectors using the one or more face segmentation vectors and the one or more limb segmentation vectors. The software instructions, when executed, may normalize, via a Softmax layer, the weighted vectors to form one or more probabilities corresponding to one or more emotions. The software instructions, when executed, may calculate, via the Softmax layer, a probability distribution based on the one or more probabilities corresponding to one or more emotions. The software instructions, when executed, may calculate, via the Softmax layer, a probability distribution based on the one or more probabilities corresponding to one or more emotions. The software instructions, when executed, may determine one or more predicted emotions based on the probability distribution. In another embodiment, the series of images may depict one or more of a customer and an agent.

The foregoing brief summary is provided merely for purposes of summarizing example embodiments illustrating some aspects of the present disclosure. Accordingly, it will be appreciated that the above-described embodiments are merely examples and should not be construed to narrow the scope of the present disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments of the present disclosure in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a device that may perform various operations in accordance with some example embodiments described herein.

FIG. 3 illustrates an example graphical user interface (GUI) used in some example embodiments described herein.

FIGS. 4A, 4B, 4C, 4D, and 4E illustrate example charts generated for the GUI in some example embodiments described herein.

FIG. 5 illustrates an example schematic block diagram used in some example embodiments described herein.

FIGS. 6A and 6B illustrate example flowcharts for generating an emotion prediction and determining a next best action or call routing, in accordance with some example embodiments described herein.

### DETAILED DESCRIPTION

Some embodiments of the present disclosure will now be described more fully hereinafter with reference to the accompanying figures, in which some, but not all, embodiments of the disclosures are shown. Indeed, these disclosures may be embodied in many different forms and should not be construed as limited to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

### Overview

As noted above, methods, apparatuses, systems, and computer program products are described herein that provide for predicting an emotion in real-time based on facial gestures and limb gestures derived from captured images. Based on the emotion prediction, methods, apparatuses, systems, and computer program products provide for a next action or personalized action for a customer interaction and/or performance management of an agent and/or branch or store. Traditionally, face-to-face customer service interactions occur in-person or via video communication. Emotions are not typically predicted during such interactions, other than via subjective interpretation performed by an agent or customer service representative. Further, feedback may simply include feedback from a customer that wishes to give feedback, which may include a small number of customers. Thus, while some customers' emotions may be provided as feedback after the fact, there is no way for a customer's emotion or current emotional state to determine next actions or be utilized for improved performance management purposes, either in real-time and/or after an interaction. Based on this, there is typically no way to determine which employees may be most suited to handling a customer experiencing a particular emotion (e.g., no personalized solution). Further, employees cannot be objectively evaluated or prioritized based on how they handle particular predicted emotions and/or based on predicted emotions determined in real-time or for each interaction.

In contrast to current subjective and personal interpretation of a customer's emotion, the present disclosure describes determining emotion and/or one or more probabilities indicating one or more emotions via machine learning models and/or classifiers based on facial gestures and/or limb gestures derived from captured images. Further, the determined emotion or probabilities may be utilized to determine a next action and also to optimize which employees or agents may interact with which customers (e.g., specific customers and/or types of customers) based on predicted emotions. Determined emotion or probabilities may also be utilized to determine an employee's or agent's performance in real-time and/or for each customer interaction. When a customer interacts with an employee or agent, via video communication or in-person, video or a series of images of the customer and/or employee or agent may be captured. All or a portion of the video or a series of images may be transmitted for image pre-processing. The pre-processing steps or operations may re-size the images, reduce noise, smooth edges, correct brightness, correct gamma, and/or perform geometric transformation, among other features. The pre-processed series of images or video may then be transmitted to body part detection circuitry. The body part detection circuitry may cause generation of one or more face segmentations and one or more limb segmentations using the pre-processed series of images or video. The one or more face segmentations may include images or video of a person's face. The one or more limb segmentations may include different viewpoints of the person's body, such as the person's hands, torso, legs, the person's entire body, and/or some combination thereof. The body part detection circuitry may extract one or more face segmentation vectors from the one or more face segmentations and may extract one or more limb segmentation vectors from each of the one or more limb segmentations.

The one or more face segmentation vectors and the one or more limb segmentation vectors may include a gesture intelligence circuitry. The gesture intelligence circuitry may cause generation of weighted vectors using the one or more face segmentation vectors and one or more limb segmentation vectors from each of the one or more limb segmentations. The gesture intelligence circuitry may include a Softmax layer. The Softmax layer may form one or more probabilities corresponding to one or more emotions from the weighted vectors. The Softmax layer may calculate a probability distribution based on the one or more probabilities corresponding to one or more emotions. Based on the probability distribution, the gesture intelligence circuitry may predict an emotion.

Accordingly, the present disclosure sets forth systems, methods, and apparatuses that accurately predict a customer's emotion based on the customer's facial gestures and limb gestures derived from captured images, unlocking additional functionality that has historically not been available. For instance, accurately predicting customer emotions during an interaction enables real-time and/or near-real-time adjustments to the customer interaction to enhance the customer experience. As another example, emotion prediction can be used to assist performance rating for an agent and/or branch or store. As agents interact with customers over time, one or more emotions may be predicted for such interactions, and such predictions may be utilized to determine the performance of a particular agent and/or branch or store over a particular time period. Corrective action may be taken in regards to particular agents and/or branches or stores with a specific net gesture index (e.g., the net gesture index based on the predicted emotion). Such an action and/or other actions describe herein may increase customer satisfaction. In particular, as patterns form over time, customer's that exhibit particular emotions may interact with particular agents.

Although a high level explanation of the operations of example embodiments has been provided above, specific details regarding the configuration of such example embodiments are provided below.

### System Architecture

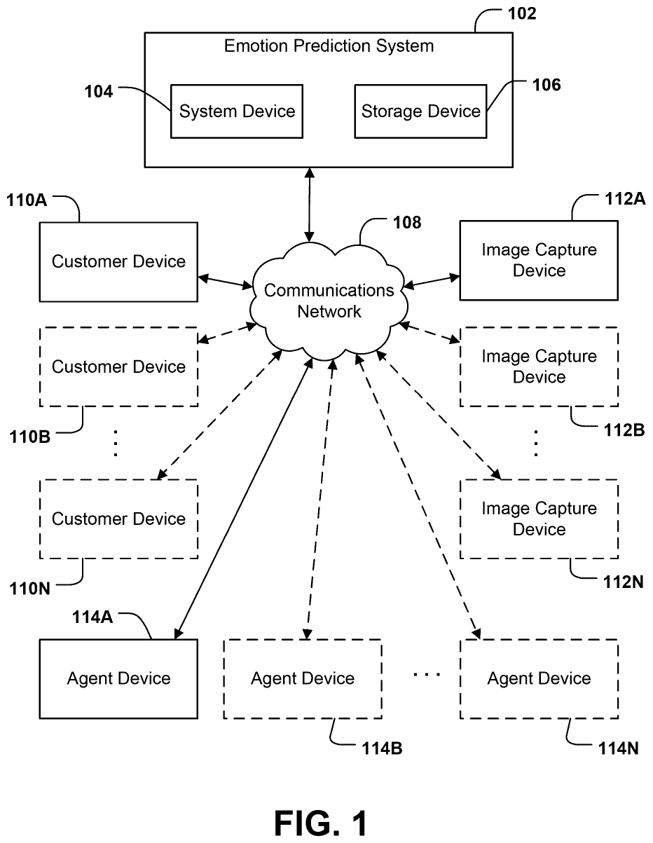

Example embodiments described herein may be implemented using any of a variety of computing devices or servers. To this end, FIG. 1 illustrates an example environment within which embodiments of the present disclosure may operate. As illustrated, an emotion prediction system 102 may include a system device 104 in communication with a storage device 106. Although system device 104 and storage device 106 are described in singular form, some embodiments may utilize more than one system device 104 and/or more than one storage device 106. Additionally, some embodiments of the emotion prediction system 102 may not require a storage device 106 at all. Whatever the implementation, the emotion prediction system 102, and its constituent system device(s) 104 and/or storage device(s) 106 may receive and/or transmit information via communications network 108 (e.g., the Internet) with any number of other devices, such as one or more of customer device 110A, customer device 110B, through customer device 110N, image capture device 112A, image capture device 112B, through image capture device 112N, and/or agent device 114A, agent device 114B, through agent device 114N.

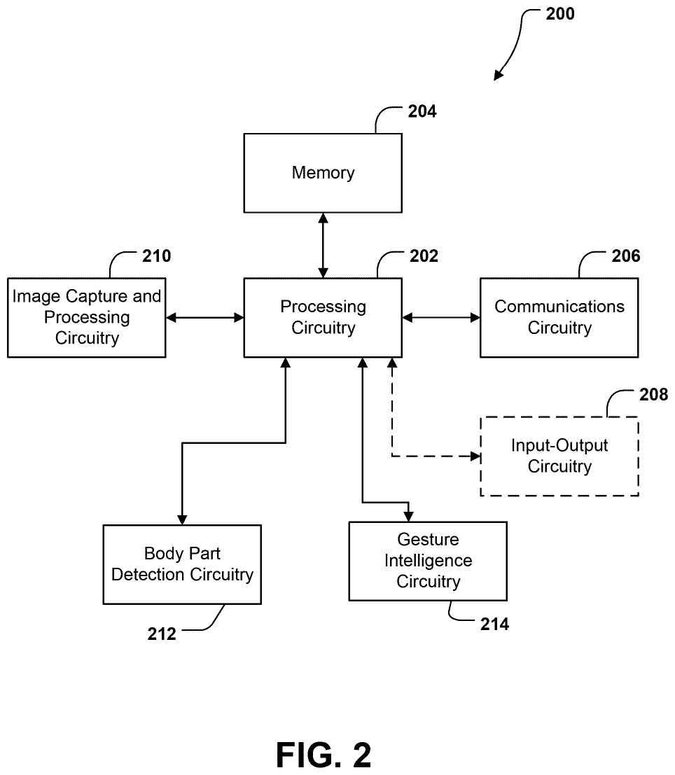

System device 104 may be implemented as one or more servers, which may or may not be physically proximate to other components of emotion prediction system 102. Furthermore, some components of system device 104 may be physically proximate to the other components of emotion prediction system 102 while other components are not. System device 104 may receive, process, generate, and transmit data, signals, and electronic information to facilitate the operations of the emotion prediction system 102. Particular components of system device 104 are described in greater detail below with reference to apparatus 200 in connection with FIG. 2.

Storage device 106 may comprise a distinct component from system device 104, or may comprise an element of system device 104 (e.g., memory 204, as described below in connection with FIG. 2). Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the emotion prediction system 102. Storage device 106 may store information relied upon during operation of the emotion prediction system 102, such as various audio recordings and speech-to-text files that may be used by the emotion prediction system 102, data and documents to be analyzed using the emotion prediction system 102, or the like. In addition, storage device 106 may store control signals, device characteristics, and access credentials enabling interaction between the emotion prediction system 102 and one or more of the customer devices 110A-110N, image capture devices 112A-112N, or agent devices 114A-114N.

The one or more image capture devices 112A-112N may be embodied by any image capture device or sensor known in the art. Similarly, the one or more customer device 112A-112N and/or agent device 114A-114N may be embodied by any computing devices known in the art, such as desktop or laptop computers, tablet devices, smartphones, or the like. The one or more customer devices 110A-110N, the one or more image capture devices 112A-112N, and the one or more agent devices 114A-114N need not themselves be independent devices, but may be peripheral devices communicatively coupled to other computing devices.

Although FIG. 1 illustrates an environment and implementation of the present disclosure in which the emotion prediction system 102 interacts with one or more of customer devices 110A-110N, image capture devices 112A-112N, and/or agent devices 114A-114N, in some embodiments one or more of the users or agents may directly interact with the emotion prediction system 102 (e.g., via input/output circuitry of system device 104), in which case a separate device may not need to be utilized for such users or agents. Whether by way of direct interaction or interaction via a separate device, users and agents may communicate with, operate, control, modify, or otherwise interact with the emotion prediction system 102 to perform functions described herein and/or achieve benefits as set forth in connection with this disclosure.

### Example Implementing Apparatuses

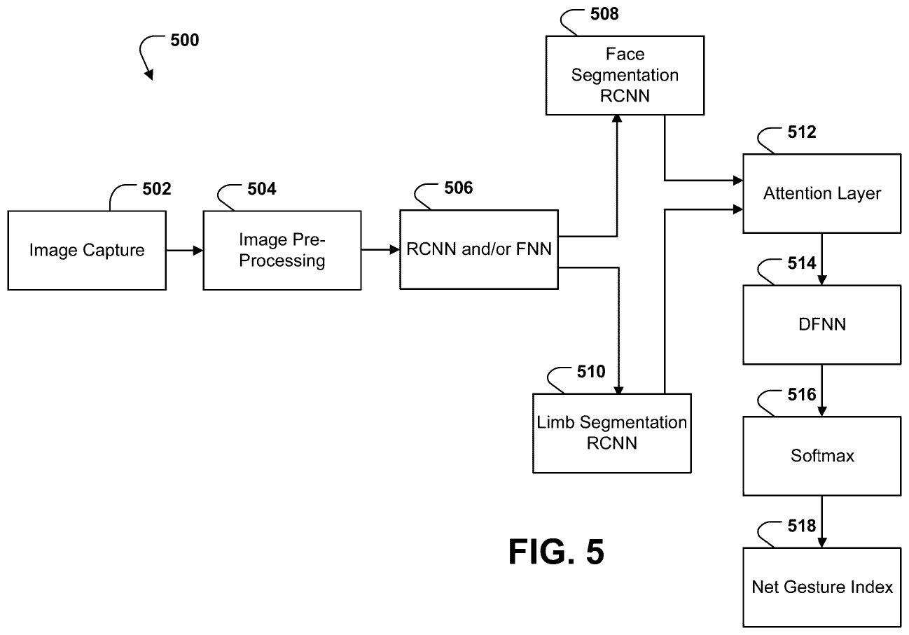

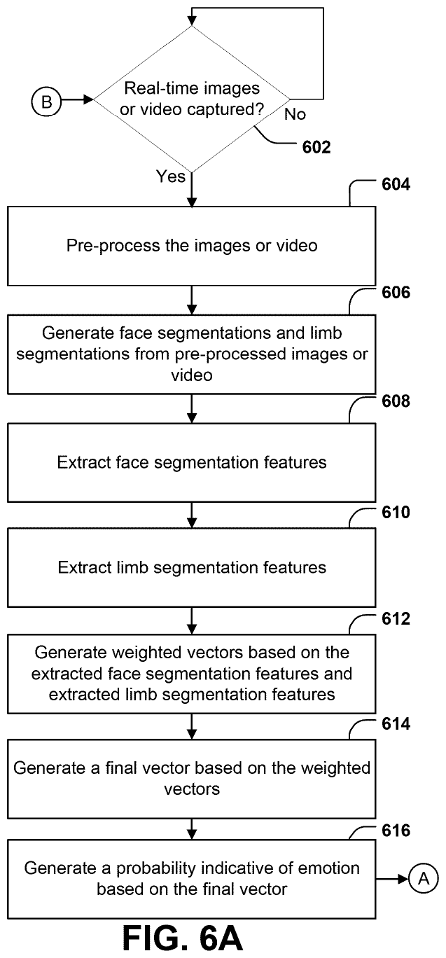

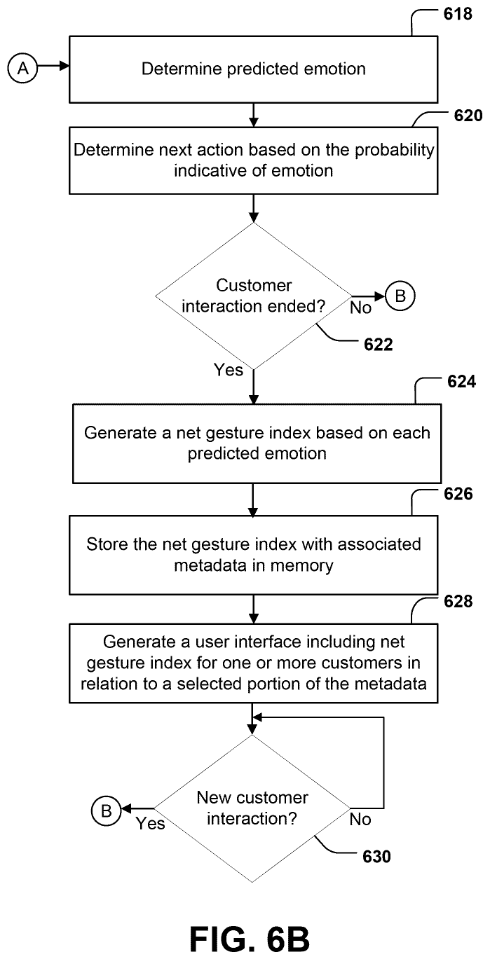

System device 104 of the emotion prediction system 102 (described previously with reference to FIG. 1) may be embodied by one or more computing devices or servers, shown as apparatus 200 in FIG. 2. As illustrated in FIG. 2, the apparatus 200 may include processor 202, memory 204, communications circuitry 206, input-output circuitry 208, image capture and processing circuitry 210, body part detection circuitry 212, and gesture intelligence circuitry 214, each of which will be described in greater detail below. While the various components are only illustrated in FIG. 2 as being connected with processor 202, it will be understood that the apparatus 200 may further comprise a bus (not expressly shown in FIG. 2) for passing information amongst any combination of the various components of the apparatus 200. The apparatus 200 may be configured to execute various operations described herein, such as those described above in connection with FIG. 1 and below in connection with FIGS. 5-6B.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications circuitry 206 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 206 may include, for example, a network interface for enabling communications with a wired or wireless communication network. For example, the communications circuitry 206 may include one or more network interface cards, antennas, buses, switches, routers, modems, and supporting hardware and/or software, or any other device suitable for enabling communications via a network. Furthermore, the communications circuitry 206 may include the processing circuitry for causing transmission of such signals to a network or for handling receipt of signals received from a network.

The apparatus 200 may include input-output circuitry 208 configured to provide output to a user and, in some embodiments, to receive an indication of user input. It will be noted that some embodiments will not include input-output circuitry 208, in which case user input (e.g., a series of images or video, or other input) may be received via a separate device such as a customer devices 110A-110N (e.g., a camera or other image capture device associated with customer devices 110A-110N) and/or agent devices 114A-114N (e.g., a camera or other image capture device associated with customer devices 110A-110N). The input-output circuitry 208 may comprise a user interface, such as a display, and may further comprise the components that govern use of the user interface, such as a web browser, mobile application, dedicated client device, or the like. In some embodiments, the input-output circuitry 208 may include a keyboard, a mouse, a touch screen, touch areas, soft keys, a microphone, a speaker, an image capture device, and/or other input/output mechanisms. In some embodiments, the input-output circuitry 208, rather than or in addition to the image capture and processing circuitry 210, may connect to image capture devices 112A-112N and receive a series of images or video directly or indirectly from the image capture devices 112A-112N. The input-output circuitry 208 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises image capture and processing circuitry 210 that may capture a series of images or video depicting a customer and/or other user, receive a series of images or video depicting a customer and/or other user, and/or pre-processes the series of images or video from the customer and/or other user. The image capture and processing circuitry 210 may utilize processor 202, memory 204, or any other hardware component included in the apparatus 200 to perform these operations, as described in connection with FIGS. 5-6B below. The image capture and processing circuitry 210 may further utilize communications circuitry 206 to gather data (e.g., a series of images or video) from a variety of sources (e.g., customer device 110A through customer device 110N, image capture device 112A through image capture device 112N, agent device 114A through agent device 114N, and/or storage device 106, as shown in FIG. 1), may utilize input-output circuitry 208 to receive data from a user, and in some embodiments may utilize processor 202 and/or memory 204 to process audio input from a customer, agent, or other user. The output of the image capture and processing circuitry 210 may be transmitted to other circuitry of the apparatus 200 (e.g., body part detection circuitry 212 and/or gesture intelligence circuitry 214). In another embodiment, the series of images or video from a customer and/or agent may be captured by other circuitry and provided or transmitted to the image capture and processing circuitry 210.

In addition, the apparatus 200 further comprises a body part detection circuitry 212 that detects different body parts in the series of images or video and/or separates each body part or body parts into segments (e.g., one or more face segmentations and/or one or more limb segmentations). The body part detection circuitry 212 may cause generation of the one or more face segmentations and/or one or more limb segmentations (e.g., via a machine learning model or classifier, such as a recurrent neural network and/or feedforward neural network), extract one or more face segmentation vectors using the one or more face segmentations (e.g., via a machine learning model or classifier, such as a face segmentation recurrent neural network), and/or extract one or more limb segmentation vectors for each of the one or more limb segmentations (e.g., via a machine learning model or classifier, such as a limb segmentation recurrent neural network). The body part detection circuitry 212 may utilize processor 202, memory 204, or any other hardware component included in the apparatus 200 to perform these operations, as described in connection with FIGS. 5 through 6B below. The body part detection circuitry 212 may further utilize communications circuitry 206 to gather data from a variety of sources (e.g., customer device 110A through customer device 110N, image capture device 112A through image capture device 112N, agent device 114A through agent device 114N, and/or storage device 106, as shown in FIG. 1), may utilize input-output circuitry 208 to receive data from a user, and in some embodiments may utilize processor 202 and/or memory 204 to generate one or more face segmentations, generate one or more limb segmentations, generate one or more face segmentation vectors, and/or generate one or more limb segmentation vectors for each of the one or more limb segmentations. The output of the body part detection circuitry 212 may be transmitted to other circuitry of the apparatus 200 (e.g., gesture intelligence circuitry 214).

In addition, the apparatus 200 may also comprise a gesture intelligence circuitry 214 that causes generation of weighted vectors using the one or more face segmentation vectors and the one or more limb segmentation vectors for each of the one or more the limb segmentations, normalizes the weighted vectors to form one or more probabilities corresponding to one or more emotions using a Softmax layer, calculates a probability distribution based on the one or more probabilities corresponding to one or more emotions using the Softmax layer, and/or determines one or more predicted emotions based on the probability distribution. The gesture intelligence circuitry 214 cause the generation of the weighted vectors using an attention layer or other machine learning algorithm, model, or classifier. The gesture intelligence circuitry 214 may additionally, prior to normalization via the Softmax layer, cause generation of final vectors using the weighted vectors and a machine learning algorithm, model, or classifier (e.g., a dense feedforward neural network or other machine learning model). The gesture intelligence circuitry 214 may additionally cause generation of one or more predicted emotions for one or more portions of a customer-agent interaction. The gesture intelligence circuitry 214 may further cause generation of a net gesture index for a customer-agent interaction based on each of the one or more predicted emotions for the customer-agent interaction. The gesture intelligence circuitry 214 may store each generated net gesture index with associated or corresponding metadata in memory 204, storage device 106, and/or other storage devices. The metadata may include a data, time, location (e.g., branch or store) of the customer-agent interaction, customer data, agent data, and/or other data related to the customer-agent interaction.

The gesture intelligence circuitry 214 may additionally generate a user interface or data related to a user interface. The user interface may include selectable options (e.g., categories) to allow a user to view different data sets related to net gesture indices for a particular set of metadata. For example, a user may view the net gesture index for a series of particular days at a particular time and for a particular agent. In such examples, the net gesture index is the aggregate of net gesture indices for that particular selection (e.g., the aggregate for those particular days at those times and for that particular agent).

The gesture intelligence circuitry 214 may determine a next action based on a particular net gesture index or indices for a particular set of metadata. The next action may, for instance, include providing one or more of personalized product recommendations and personalized service recommendations. For example, a customer may be offered products or services in response to factors indicative of a poor customer emotional state. The next action may, in addition, relate to management of employees. For example, if an agent has a lower than normal or typical score for a particular day, a next action may include shifting the agents schedule. In another example, the next action may be determined real-time, while a customer-agent interaction is occurring. For example, if an agent is exhibiting a net gesture index lower than a specified threshold, the agent and/or the agent's supervisor or manager may receive an alert. The alert may indicate potential next actions to alleviate a customer's distress indicated by one or more predicted emotions. Next actions may include shifting a manager or supervisor in a customer-agent interaction, directing the customer to another agent, notifying the customer of potential solutions, and/or notifying the customer of services and/or products, among other actions.

The gesture intelligence circuitry 214 may include a max pooling layer. The max pooling layer may be utilized at various points throughout the steps described herein to reduce dimensionality of any generated vectors.

The gesture intelligence circuitry 214 may utilize processor 202, memory 204, or any other hardware component included in the apparatus 200 to perform these operations, as described in connection with FIGS. 5 through 6B below. The gesture intelligence circuitry 214 may further utilize communications circuitry 206 to gather data from a variety of sources (e.g., customer device 110A through customer device 110N, image capture device 112A through image capture device 112N, agent device 114A through agent device 114N, or storage device 106, as shown in FIG. 1), may utilize input-output circuitry 208 to receive data from a user, and in some embodiments may utilize processor 202 and/or memory 204 to create weighted vectors, final vectors, likelihoods of particular emotions, probability distributions, one or more predicted emotions, net gesture indices, user interfaces or data for a user interface. The output of the gesture intelligence circuitry 214 may be transmitted to other circuitry of the apparatus 200.

Although components 202-214 are described in part using functional language, it will be understood that the particular implementations necessarily include the use of particular hardware. It should also be understood that certain of these components 202-214 may include similar or common hardware. For example, the image capture and processing circuitry 210, body part detection circuitry 212, and gesture intelligence circuitry 214 may each at times leverage use of the processor 202, memory 204, communications circuitry 206, or input-output circuitry 208, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the image capture and processing circuitry 210, body part detection circuitry 212, and gesture intelligence circuitry 214 may leverage processor 202, memory 204, communications circuitry 206, or input-output circuitry 208 as described above, it will be understood that any of these elements of apparatus 200 may include one or more dedicated processors, specially configured field programmable gate arrays (FPGA), or application specific interface circuits (ASIC) to perform its corresponding functions, and may accordingly leverage processor 202 executing software stored in a memory (e.g., memory 204), or memory 204, communications circuitry 206 or input-output circuitry 208 for enabling any functions not performed by special-purpose hardware elements. In all embodiments, however, it will be understood that the image capture and processing circuitry 210, body part detection circuitry 212, and gesture intelligence circuitry 214 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200 Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments of the present disclosure are described below in connection with a series of graphical user interfaces and flowcharts.

### GUI

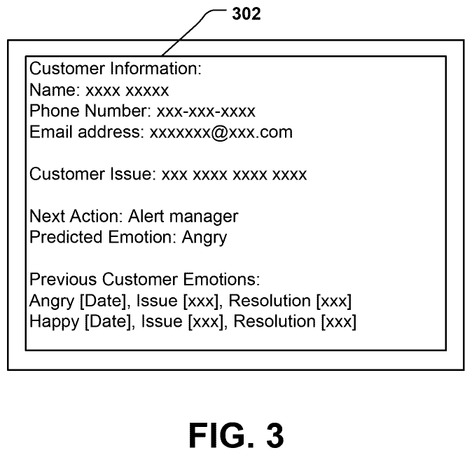

Turning to FIG. 3, a graphical user interface (GUI) 302 is provided that illustrates what an agent sees after a prediction is made. As noted previously, the agent may interact with the emotion prediction system 102 by directly engaging with input-output circuitry 208 of an apparatus 200 comprising a system device 104 of the emotion prediction system 102. In such an embodiment, the GUI shown in FIG. 3 may be displayed to the agent by the apparatus 200. Alternatively, the agent may interact with the emotion prediction system 102 using a separate agent device (e.g., any of agent devices 114A-114N, as shown in FIG. 1), which may communicate with the emotion prediction system 102 via communications network 108. In such an embodiment, the GUI 302 shown in FIG. 3 may be displayed to the agent by the agent device.

As described herein, a customer may interact with an agent or customer service representative in-person or from a customer device (e.g., any of customer devices 110A-110N, as shown in FIG. 1). A series of images or video of the customer and/or the agent may be taken or transmitted by an image capture device (e.g., any of image capture devices 112A-112N) to the emotion prediction system 102. This information may be received by the emotion prediction system 102, which may in turn identify the customer's and/or agent's emotion and may, based on that identified emotion, cause information relating to next actions to be transmitted to the agent device. In addition to causing transfer of next actions to the agent device, various data points may be transmitted to the agent device. The GUI 302 may thereafter present such information for review by the agent using the agent device. The information may include a customer's personal information, the reason (if known) that a customer initiated the interaction, the customer's predicted emotion, and any previous predicted customer emotions (e.g., from the same interaction or a previous interaction). Knowledge of the customer's predicted emotion may allow for the agent to act appropriately to address the customer more successfully than may otherwise be expected.

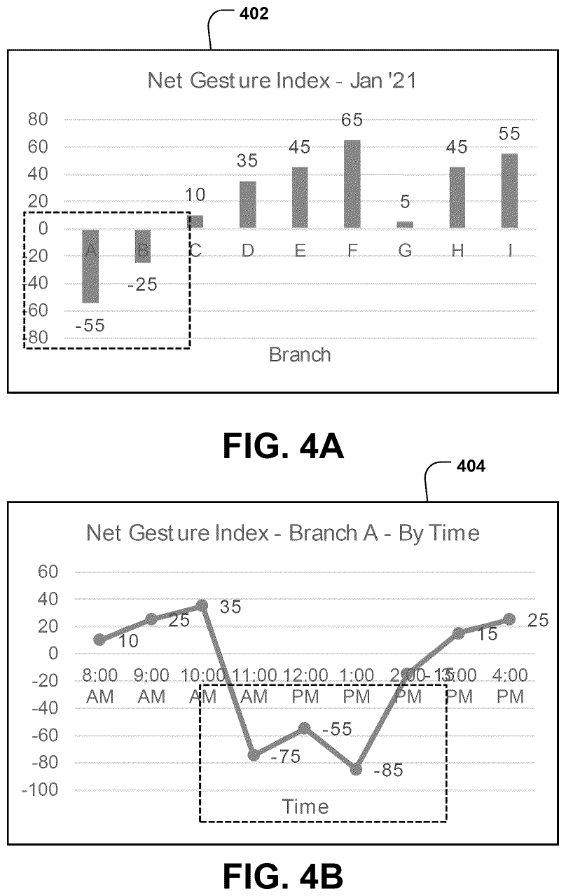

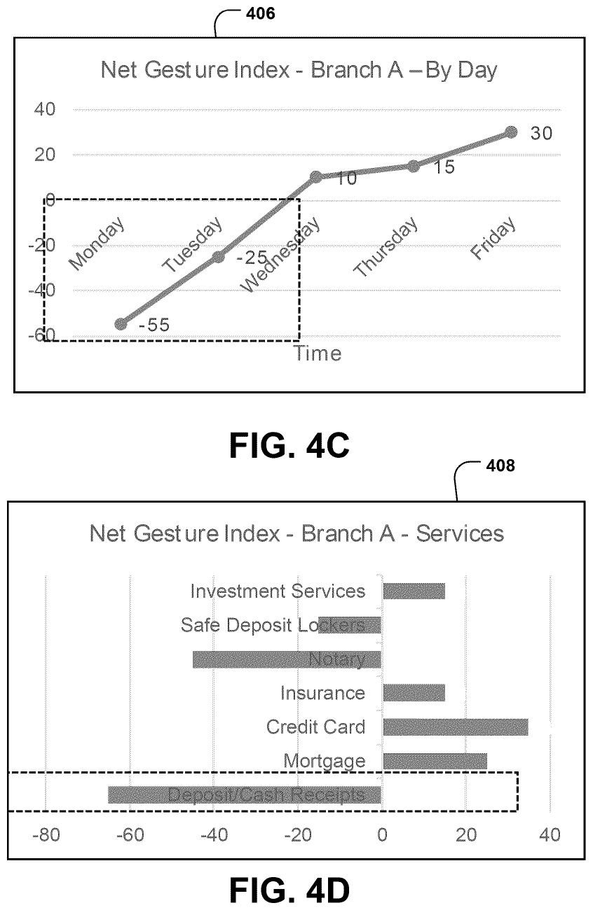

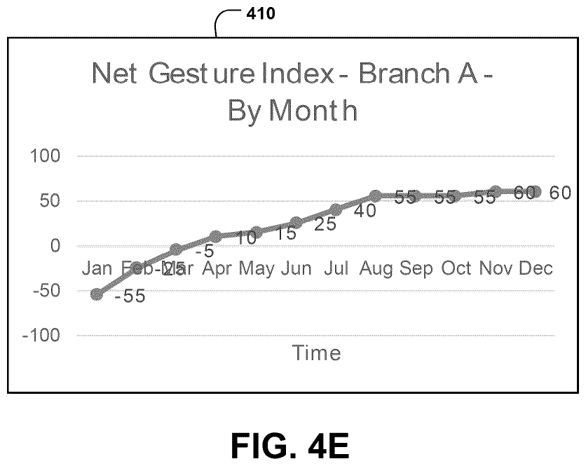

Turing to FIGS. 4A through 4E, various charts that may be displayed via a GUI to an agent or other employee are illustrated. As noted previously, the emotion prediction system 102 may generate a net gesture index for a customer-agent interaction. As data is gathered over time, the GUI may include options to view different data sets. For example, and as illustrated in FIG. 4A, one chart 402 or view may include the aggregated net gesture index gathered for each employee of a specified branch for a specified month. As illustrated in FIG. 4B, another chart 404 may include the aggregated net gesture index over time for a specified day and specified branch. As illustrated in FIG. 4C, another chart 406 may include the aggregated net gesture index over specified days for a specified branch. As illustrated in FIG. 4C, another chart 408 may include the aggregated net gesture index over specified days for a specified branch. As illustrated in FIG. 4D, another chart 404 may include the aggregated net gesture index for specified entities or services for a specified branch. As illustrated in FIG. 4E, another chart 410 may include the aggregated net gesture index over specified months for a specified branch. The GUI may allow a user to view these different charts and other charts illustrating different metadata sets based on user selected or selectable options. Such options may be selectable via a dropdown menu, a drag and drop interface, or text entry box. After selecting such options, the GUI may generate the chart based on the selections. Based on the output for a particular set of metadata, a user or the emotion prediction system 102 may take corrective action. Corrective action may include re-scheduling specified employees' work hours, altering job duties for specified employees, ensuring particular customers meet with specified agents, and/or increasing/decreasing employees at a specified branch.

### Example Operations

Turning first to FIG. 5, a schematic block diagram 400 is shown that represents an example emotion prediction flow, as, for example, implemented by emotion prediction system 102, via system device 104, which may comprise an apparatus 200. To perform the operations described below, the apparatus 200 may utilize one or more of processor 202, memory 204, communications circuitry 206, input-output circuitry 208, image capture and processing circuitry 210, body part detection circuitry 212, gesture intelligence circuitry 214, and/or any combination thereof. It will be understood that user interaction with the emotion prediction system 102 may occur directly via input-output circuitry 208, or may instead be facilitated via one of agent devices 114A-114N, as shown in FIG. 1, and which may have similar or equivalent physical componentry facilitating such user interaction.

As illustrated in FIG. 5, such an example may begin with image capture 502. Circuitry of apparatus 200 (e.g., such as image capture and processing circuitry 210) may capture or record a series of images or videos of a customer, agent, and/or other user at 502. The captured series of images or video may be transmitted for image pre-processing 504 (which may be performed by a separate component or which may additionally be performed or executed by image capture and processing circuitry 210). The image pre-processing 504 may resize the series of images or video, denoise the series of images or video, smooth edges series of the images or video, correct brightness and/or gamma, perform geometric transformation, and/or perform other functions or operations to enable further emotion predictions.

Next, a recurrent convolutional neural network (RCNN) and/or feedforward neural network (FNN) 506 may be utilized to generate or cause generation of one or more face segmentations and one or more limb segmentation. In some embodiments, padding may be utilized prior to processing via the RCNN and/or FNN 506. In such embodiments, a border of specified pixels (e.g., 0 or 1) may be added to each of the series of images or video. After, padding, each of the images may be passed through one or more convolutional neural network (CNN) layers with a specified stride (e.g., (1, 1), (2, 2), etc.). The output will be passed through a max pooling layer. The max pooling layer may be utilized at various points throughout the steps described herein to reduce dimensionality of the output of the one or more CNN layers. The reduced dimensionality output may be further processed via a batch normalization to re-scale or re-center the reduced dimensionality output. Finally, the normalized and reduced dimensionality output may be passed through one or more flattening layers to produce a 1 dimensional array for one or more face segmentations and one or more limb segmentations.

Next, one or more face segmentations may be applied by a face segmentation RCNN 508 including one or more layers. The face segmentation RCNN 508 may produce one or more face segmentation vectors. The one or more face segmentation vectors may be transmitted to a max pooling layer to reduce dimensionality of the one or more face segmentation vectors. The one or more reduced dimensionality face segmentation vectors may be transmitted to a batch normalization layer to re-scale or re-center the one or more reduced dimensionality face segmentation vectors.

Similarly, the one or more limb segmentations may be applied by a limb segmentation RCNN 510 including one or more layers. The limb segmentation RCNN 510 may produce one or more limb segmentation vectors. The one or more limb segmentation vectors may be transmitted to a max pooling layer to reduce dimensionality of the one or more limb segmentation vectors. The one or more reduced dimensionality limb segmentation vectors may be transmitted to a batch normalization layer to re-scale or re-center the one or more reduced dimensionality limb segmentation vectors.

Next, each output from face segmentation RCNN 508 and limb segmentation RCNN 510 (e.g., one or more face segmentation vectors and one or more limb segmentation vectors) may be transmitted to an attention layer 512. The attention layer 512 is used to learn the alignment between the hidden vectors corresponding to face and limb segmentations (e.g., from one or more face segmentation vectors and one or more limb segmentation vectors). Each aligned vector is created as the normalized weighted sum of the face and limb segmentation vectors. These normalized weights act as attentions and are obtained as the weighted combination of the face and limb segmentation vectors where the weights/parameters are learned during training.

Each aligned vector is further refined into final vectors via a Deep FFN (DFNN) 514. The DFNN 514 may include one or more layers and a batch normalization layer. Next, the final vectors may be transmitted to Softmax function 516. Determining an emotion may be treated as a multi-class classification problem. Thus, Softmax activation is used which is a generalization of logistic function to multiple dimensions. The Softmax function 516 takes the final vector from the DENN 514 and normalizes it into probability distribution consisting of M probabilities, where M is the number of dimensions of the final vector. Thus, the output of the Softmax function 516 may consist of values between 0 and 1. The emotion class corresponding to the maximum probability score is considered as a final prediction from the model.

As noted, the final prediction or one or more predicted emotions may be utilized to determine a net gesture index 518 and/or a next action. In an embodiment, a plurality of predicted emotions may be determined for a customer-agent interaction. In such embodiments, the net gesture index 518 may be comprised of a score based on each of the one or more predicted emotion for the customer-agent interaction.

Such actions or functions, as described in relation to FIG. 5, may be performed, stored in, and/or executed by the circuitry of apparatus 200 and/or the emotion prediction system 102. For example, each machine learning algorithm, model, or classifier (e.g., RCNN and FNN 506, face segmentation RCNN 508, limb segmentation RCNN 510, and DENN 514) in FIG. 5 may be stored, as instructions, in memory 204, body part detection circuitry 212, and/or gesture intelligence circuitry 214 and may be utilized by body part detection circuitry 212 and/or gesture intelligence circuitry 214.

Turning to FIGS. 6A and 6B, flowcharts are illustrated that contain example operations implemented by example embodiments described herein. The operations illustrated in FIGS. 6A and 6B may, for example, be performed by system device 104 of the emotion prediction system 102 shown in FIG. 1, which may in turn be embodied by an apparatus 200, which is shown and described in connection with FIG. 2. To perform the operations described below, the apparatus 200 may utilize one or more of processor 202, memory 204, communications circuitry 206, input-output circuitry 208, image capture and processing circuitry 210, body part detection circuitry 212, gesture intelligence circuitry 214, and/or any combination thereof. It will be understood that user interaction with the emotion prediction system 102 may occur directly via input-output circuitry 208, or may instead be facilitated by agent devices 114A-114N, as shown in FIG. 1, and which may have similar or equivalent physical componentry facilitating such user interaction.

As shown by operation 602, the apparatus 200 includes means, such as processor 202, communications circuitry 206, input-output circuitry 208, image capture and processing circuitry 210, or the like, for determining whether images, a series of images, or video are captured. Such a capture may occur in real time. In an embodiment, the series of images or video may be captured via one or more of customer devices 110A-110N, image capture devices 112A-112N, and agent devices 114A-114N. Further, image or video capture may occur automatically as a customer-agent interaction begins. In another embodiment, prior to capturing a series of images or videos a permission may be requested from a customer or notification given to a customer. If permission is received, then image or video capture may occur. Operation 602 may continuously loop until the apparatus 200 determines that real-time images or video are captured. The captured series of images or video may depict a portion of a customer interaction between the customer and/or the agent. In an embodiment, the series of images or video may be processed in segments (e.g., one minute, two minutes, three minutes, or more of images or video). In this way, a plurality of predicted emotions may be determined over the course of the customer-agent interaction.

As shown by operation 604, the apparatus 200 includes means, such as processor 202, communications circuitry 206, input-output circuitry 208, image capture and processing circuitry 210, or the like, for pre-processing the captured series of images or video. Such pre-processing may reduce any noise, resize each of the series of images or portions of the video, smooth edges, correct brightness, correct gamma, and/or perform geometric transformation. The image capture and processing circuitry 210 may resize the images to a base size, as some images may vary in size. Further, the image capture and processing circuitry 210 may denoise an image by reproducing the image with a smooth blur (e.g., Gaussian blur), among other image denoising techniques as will be understood by a person skilled in the art. The image capture and processing circuitry 210 may additionally detect and smooth the edges of the image (e.g., via filtering or further blurring). Then the image capture and processing circuitry 210 may adjust pixel brightness (e.g., via gamma correction). Finally, the image capture and processing circuitry 210 may perform geometric transformation (e.g., scaling, rotation, translation, and/or shear).

As shown by operation 606, the apparatus 200 includes means, such as body part detection circuitry 212 or the like, for generating face segmentations and limb segmentations from the pre-processed series of images or video. The body part detection circuitry 212 may include one or more machine learning algorithms, models, or classifiers (e.g., an RCNN and/or FNN). Using such machine learning algorithms, the body part detection circuitry 212 may segment or isolate different portions of the series of images or video. Such segments may include a customer's and/or agent's face, arms, legs, torso, hands, feet, and/or some combination thereof. Thus, the body part detection circuitry 212 may cause generation of one or more face segmentations and one or more limb segmentations.

As shown by operation 608, the apparatus 200 includes means, such as body part detection circuitry 212 or the like, for extracting face segmentation features or vectors from the face segmentations. The body part detection circuitry 212 may include one or more machine learning algorithms, models, or classifiers (e.g., an RCNN). Using such machine learning algorithms, the body part detection circuitry 212 may cause generation or may determine the face segmentation features or vectors (e.g., as an output of the machine learning algorithms).

As shown by operation 610, the apparatus 200 includes means, such as body part detection circuitry 212 or the like, for extracting one or more limb segmentation features or vectors from the limb segmentations. The body part detection circuitry 212 may include one or more machine learning algorithms, models, or classifiers (e.g., an RCNN). Using such machine learning algorithms, the body part detection circuitry 212 may cause generation or may determine the one or more limb segmentation features or vectors (e.g., as an output of the machine learning algorithms).

As shown by operation 612, the apparatus 200 includes means, such as gesture intelligence circuitry 214 or the like, for generating weighted vectors based on the extracted face segmentation features or vectors and extracted limb segmentations features or vectors. Operation 612 may be performed by an attention layer included or stored in the gesture intelligence circuitry 214.

As shown by operation 614, the apparatus 200 includes means, such as gesture intelligence circuitry 214 or the like, for generating a final vector based on the weighted vector. The final vector may be generated by a machine learning algorithm included in or stored in the gesture intelligence circuitry 214.

As shown by operation 616, the apparatus 200 includes means, such as gesture intelligence circuitry 214 or the like, for generating a probability indicative of emotion based on the final vector via a Softmax module or layer. The Softmax module or layer takes the final vector and normalizes it into a probability distribution consisting of M probabilities. Thus, the output of the Softmax module or layer consists of values between 0 and 1. From operation 616, the process advances to operation 618, shown in FIG. 6B

As shown by operation 618, the apparatus 200 includes means, such as gesture intelligence circuitry 214 or the like, for predicting the customer's and/or agent's emotions. The gesture intelligence circuitry 214 may determine or predict the customer's and/or agent's emotion based on the output from the Softmax module or layer. For example, a series of the probabilities may be output from the Softmax module or layer for each of the M probabilities. The gesture intelligence circuitry 214 may select the emotion with the highest probability as the predicted emotion or one of the one or more predicted emotions. In another example, the gesture intelligence circuitry 214 may predict emotion based on a combination of the probabilities output from the Softmax module or layer

As shown by operation 620, the apparatus 200 includes means, such as gesture intelligence circuitry 214 or the like, for determining the next action or best action based on the one or more predicted emotions. The gesture intelligence circuitry 214 may determine the next action or best action based on the one or more predicted emotions and other factors. Other factors may include any previous one or more predicted emotions for a customer-agent interaction, whether the one or more predicted emotions are progressively worsening (e.g., a customer's emotion transitions from upset to angry), whether other agents are available, whether a manager or supervisor is available, and/or the customer's history of one or more predicted emotions from other customer-agent interactions, among other factors.

As shown by operation 622, the apparatus 200 includes means, such as gesture intelligence circuitry 214 or the like for determining whether a customer interaction has ended. The gesture intelligence circuitry 214 may determine whether the customer interaction has ended based on agent and/or customer input (e.g., an agent indicates that the interaction is over) or based on other factors, such as whether communication has ended for video based communications or if the apparatus no longer detects the customer from the current customer interaction. If the interaction has ended, then the process moves to operation 624, otherwise additional emotions may be predicted for the interaction based on additional images captured in real-time during the interaction.

As shown by operation 624, the apparatus 200 includes means, such as gesture intelligence circuitry 214 or the like for generating a net gesture index based on each of the one or more predicted emotions for a customer interaction. The net gesture index may be comprised of a score based on each of the one or more predicted emotions for the customer-agent interaction. In such embodiments, the net gesture index may be a number. The number may be between a positive and negative range. Further, a negative number may be indicative of negative emotions (e.g., a customer was angry), while a positive number may be indicative of positive emotions (e.g., the customer was happy).

As shown by operation 626, the apparatus 200 includes means, such as gesture intelligence circuitry 214 or the like for storing the net gesture index along with corresponding or associated metadata in memory. The memory may include memory 204, storage device 106, or other memory of the apparatus 200 or emotion prediction system 102.

As shown by operation 628, the apparatus 200 includes means, such as gesture intelligence circuitry 214 or the like for generating a user interface including the net gesture index for one or more customers related to a selected portion of the metadata. The user interface may include one or more selectable categories corresponding to the associated metadata, to enable a user to view different data sets. For example, a user may select a time, day, week, month, year, one or more branches, one or more stores, and/or one or more agents, one or more customers, among other factors. Once the user selects one or more of the various options, the gesture intelligence circuitry 214 may generate a chart illustrating such selections.

As shown by operation 630, the apparatus 200 includes means, such as gesture intelligence circuitry 214 or the like for determining whether a new customer interaction is beginning. The gesture intelligence circuitry 214 may make such determinations based on an agent's input. For example, an agent may click a button in the user interface of the agent's device. In another example, when the gesture intelligence circuitry 214 detects a new customer, the process may move to operation 602.

In another embodiment, the operations illustrated in FIGS. 6A and 6B may be an iterative or continuous process. As a customer interaction proceeds, the apparatus 200 or emotion prediction system 102 may continuously predict a customer's and/or agent's prediction. Further, as the interaction proceeds, a customer's, as well as the agent's, emotions may change. As such, emotion may be predicted continuously. Further, the next action may change as the interaction progresses, based on the current or most recently one or more predicted emotions, as well as previous predictions for the current interaction. Further still, emotions predicted at different times may be weighted differently based on the time of the prediction in relation to the interaction. The apparatus 200 includes means, such as the gesture intelligence circuitry 214, to determine which portion of an interaction an emotion is being predicted for, e.g., the beginning, the end, or a portion in between. The gesture intelligence circuitry 214 may weight the one or more predicted emotions based on the time of the portion of the interaction. For example, an earlier prediction may be given a higher weight than a later prediction, when determining a next action. In another example, the later one or more predicted emotions may be given a higher weight than the earlier one or more predicted emotions. Further, weight may be given to emotions based on changes from previous emotions (e.g., from happy to angry).

In addition to the customer's emotion, as noted, an agent's emotion may be predicted. The agent's emotion may be utilized to determine the agent's performance or to create a history of emotions in response to particular customer emotions. Such a history may be utilized when determining next actions for a particular interaction.

Once the next action or best action has been determined, the gesture intelligence circuitry 214 may display such an action to the agent's device. Further, the one or more predicted emotions, the net gesture index, and/or the next actions may be displayed to a supervisor's or manager's device in real-time, allowing a supervisor or manager to take corrective action as necessary (e.g., if during an interaction there is an indication of negative emotions or a negative net gesture index, then a supervisor or manager may intervene).

As described above, example embodiments provide methods and apparatuses that enable improved emotion prediction, interaction resolution, and agent performance. Example embodiments thus provide tools that overcome the problems faced during typical customer interactions and problems faced in determining agent performance. By predicting emotion in real-time based on facial and limb gestures, a more accurate emotion prediction may be made and utilized during interactions, rather than only after the interaction. Moreover, embodiments described herein avoid less accurate predictions. The use of multiple machine learning algorithms and the use of facial and limb gestures, provide for a more accurate prediction, thus predicting a customer's emotion based on nuanced gestures or changes in gestures.

As these examples all illustrate, example embodiments contemplated herein provide technical solutions that solve real-world problems faced during and after customer interactions with customers exhibiting anger or otherwise unsatisfactory emotions. And while customer satisfaction has been an issue for decades, there is no current solution for determining emotion real-time in-person or over video communication. As the demand for customer satisfaction significantly grows, a solution to resolve this issue does not exist. At the same time, the recently arising ubiquity of image capture, image analysis, and machine learning has unlocked new avenues to solving this problem that historically were not available, and example embodiments described herein thus represent a technical solution to these real-world problems.

FIGS. 5 through 6B illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for predicting an emotion in real-time based on facial gestures and limb gestures derived from captured images, the method comprising:
receiving, by an image capture and processing circuitry, a series of images captured in real-time, wherein the series of images depict a customer interaction;
causing, by a body part detection circuitry and using the series of images, generation of one or more face segmentations and one or more limb segmentations;
extracting, by the body part detection circuitry and using the one or more face segmentations, one or more face segmentation vectors;
extracting, by the body part detection circuitry and using the one or more limb segmentations, one or more limb segmentation vectors;
causing, by a gesture intelligence circuitry, generation of weighted vectors using the one or more face segmentation vectors and the one or more limb segmentation vectors;
normalizing, via a Softmax layer of the gesture intelligence circuitry, the weighted vectors to form one or more probabilities corresponding to one or more emotions;
determining, by the gesture intelligence circuitry, a weight for each of the one or more emotions, wherein the weight is based on a change from a previously predicted emotion to a particular emotion of the one or more emotions;
calculating, via the Softmax layer of the gesture intelligence circuitry and based on the weight for each of the one or more emotions, a probability distribution based on the one or more probabilities corresponding to the one or more emotions; and
determining, by the gesture intelligence circuitry, one or more predicted emotions based on the probability distribution.

2. The method of claim 1, further comprising:
prior to extraction of the one or more face segmentations and the one or more limb segmentations, pre-processing, by the image capture and processing circuitry, the series of images.

3. The method of claim 2, wherein pre-processing the series of images includes applying one or more resizing, denoising, smoothing edges, brightness correction, gamma correction, or geometric transformation operations to the series of images.

4. The method of claim 1, wherein each of the one or more limb segmentations includes a portion of a customer's or agent's body that is different than that of each other of the one or more limb segmentations.

5. The method of claim 1, wherein causing the generation of the one or more face segmentations and the one or more limb segmentations includes using one or more of a recurrent convolutional neural network and a feedforward network.

6. The method of claim 5,
wherein the body part detection circuitry includes a face segmentation recurrent convolutional neural network and a limb segmentation recurrent convolutional neural network,
wherein extracting the one or more face segmentation vectors uses the face segmentation recurrent convolutional neural network, and
wherein extracting the one or more limb segmentation vectors uses the limb segmentation recurrent convolutional neural network.

7. The method of claim 1, further comprising:
prior to normalizing the weighted vectors, causing, by the gesture intelligence circuitry, generation of final vectors using the weighted vectors and a dense feedforward neural network.

8. The method of claim 1, wherein the series of images depict a portion of a customer interaction, and wherein the one or more predicted emotions include a specific predicted emotion for each portion of the customer interaction in real-time.

9. The method of claim 8, further comprising:
causing, by the gesture intelligence circuitry, generation of a net gesture index using the specific predicted emotion for each portion of the customer interaction.

10. The method of claim 9, further comprising:
storing the net gesture index of the customer interaction with associated metadata in memory.

11. The method of claim 10, further comprising:
generating, via gesture intelligence circuitry, a user interface including previously generated net gesture indices in relation to one or more selectable categories corresponding to the associated metadata.

12. The method of claim 1, further comprising:
determining, by the gesture intelligence circuitry and based on the one or more predicted emotions, a next action in real-time, wherein the next action is determined while the customer interaction occurs.

13. The method of claim 12, wherein the next action includes providing one or more of personalized product recommendations and personalized service recommendations.

14. The method of claim 12, wherein each of the one or more predicted emotions corresponds to a portion of a current customer interaction and wherein determining the next action is further based on previously predicted emotions of prior portions of the current customer interaction.

15. An apparatus for predicting an emotion in real-time based on facial gestures and limb gestures derived from captured images, the apparatus comprising:
an image capture and processing circuitry configured to receive a series of images captured in real-time, wherein the series of images depict a customer interaction;
a body part detection circuitry configured to:
cause, using the series of images, generation of one or more face segmentations and one or more limb segmentations,
extract, using the one or more face segmentations, one or more face segmentation vectors, and
extract, using each of the one or more limb segmentations, one or more limb segmentation vectors; and
a gesture intelligence circuitry configured to:
cause generation of weighted vectors using the one or more face segmentation vectors and the one or more limb segmentation vectors,
normalize, via a Softmax layer, the weighted vectors to form one or more probabilities corresponding to one or more emotions,
determine a weight for each of the one or more emotions, wherein the weight is based on a change from a previously predicted emotion to a particular emotion of the one or more emotions,
calculate, via the Softmax layer and based on the weight for each of the one or more emotions, a probability distribution based on the one or more probabilities corresponding to the one or more emotions, and
determine one or more predicted emotions based on the probability distribution.

16. The apparatus of claim 15, the series of images depict one or more of an agent and a customer.

17. The apparatus of claim 16, wherein the gesture intelligence circuitry is further configured to determine an agent's performance based on the one or more predicted emotions.

18. The apparatus of claim 15, wherein the body part detection circuitry includes a face segmentation recurrent convolutional neural network and a limb segmentation recurrent convolutional neural network,
wherein extraction the one or more face segmentation vectors uses the face segmentation recurrent convolutional neural network, and
wherein extraction the one or more limb segmentation vectors uses the limb segmentation recurrent convolutional neural network.

19. A computer program product for predicting a customer's emotions, the computer program product comprising at least one non-transitory computer-readable storage medium storing software instructions that, when executed, cause an apparatus to:
receive a series of images captured in real-time, wherein the series of images depict a customer interaction;
cause, using the series of images, generation of one or more face segmentations and one or more limb segmentations;
extract, using the one or more face segmentations, one or more face segmentation vectors;
extract, using the one or more limb segmentations, one or more limb segmentation vectors;
cause generation of weighted vectors using the one or more face segmentation vectors and the one or more limb segmentation vectors;
normalize, via a Softmax layer, the weighted vectors to form one or more probabilities corresponding to one or more emotions;
determine a weight for each of the one or more emotions, wherein the weight is based on a change from a previously predicted emotion to a particular emotion of the one or more emotions;
calculate, via the Softmax layer and based on the weight for each of the one or more emotions, a probability distribution based on the one or more probabilities corresponding to the one or more emotions; and
determine one or more predicted emotions based on the probability distribution.

20. The computer program product of claim 19, wherein the series of images depict one or more of a customer and an agent.
